(19) United States
(12) Patent Application Publication
(10) Pub. No.: US 2007/0074125 A1
(43) Pub. Date: Mar. 29, 2007

(54) Preview information for web-browsing

(75) Inventors: John C. Platt, Redmond, WA (US); Ramez Naam, Seattle, WA (US); Oliver Hurst-Hiller, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/234,204

(22) Filed: Sep. 26, 2005

(51) Int. Cl. G06F 9/00

(52) U.S. Cl. 715/760; 715/764; 715/781; 715/968

(57) ABSTRACT

The invention describes a method for displaying preview information to a user for either a website the user is currently browsing or for a website that the user may consider visiting. The invention can be configured to display a web link to a user and to detect a trigger event. Additionally the invention can be configured to retrieve and present the preview information to a user in a UI once a trigger event has been detected.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Users browsing the Internet may need to make judgments about websites that they are currently visiting or about websites that they may consider visiting. A user may want to know whether the website is it trustworthy, whether the website is current, whether the website is relevant to any information needed, whether there will be pop-up ads or malware on the web, etc. Internet search engines can be a source that can provide such information. Although Internet search engines contain a variety of information about websites that may be useful to users in making these evaluations, this information may not be readily available to users in the immediate context of their web browsing activity.

### SUMMARY

The invention discloses a system and method for displaying preview information for a website. The method can include displaying a web link and detecting a trigger event corresponding to the web link. Additionally, once the trigger event has been detected, the method can include aggregating a plurality of data items corresponding to the web link. Moreover, the method can include displaying the plurality of data items.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an embodiment of a system of the invention.

FIG. 2 illustrates an embodiment of a method for displaying preview information within a UI.

FIG. 3 illustrates an embodiment of a UI for displaying preview information for a website a user is currently browsing.

FIG. 4 illustrates an embodiment of a UI for displaying preview information for a website that a user may consider visiting.

### DETAILED DESCRIPTION

The invention can be configured to display preview information about a website that corresponds to a web link. The preview information can be displayed for a website that a user may consider visiting or for a website the user is currently browsing. The preview information can include any type of information about a website such as performance, trustworthiness, popularity, and any other information regarding a website. Additionally, the preview information can be any information regarding a website that can be available to a search engine or that can be indexed by a search engine. The preview information can be presented to a user upon detection of a trigger event such as any event, action, or occurrence that can initiate a request for the preview information. The preview information can be presented for any accessible web link encountered on a user interface (UI). Upon detection of a trigger event, the preview information can be presented to a user in a UI in a separate location other than a main viewing section.

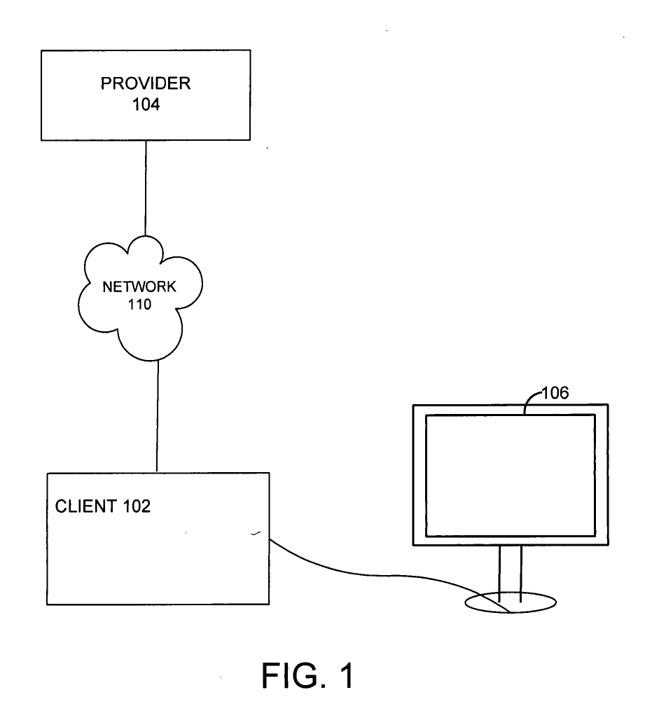

FIG. 1 illustrates an embodiment of a system of the invention. Client 102 and provider 104 may be or include a desktop or laptop computer, a network-enabled cellular telephone, wireless email client, or other client, machine or device to perform various tasks including Web browsing, search, electronic mail (email) and other tasks, applications and functions. Client 102 and provider 104 may be or can include a server including, for instance, a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. Client 102 and provider 104 may additionally be any portable media device such as digital still camera devices, digital video cameras, media players such as personal music players and personal video players, and any other portable media devices.

Client 102 and provider 104 can each include a communication interface. The communication interface may be an interface that can allow the client to be directly connected to provider 104 or allows the client 102 to be connected to the provider over network 108. Network 108 can include, for example, a local area network (LAN), a wide area network (WAN), or the Internet. In an embodiment, the client 102 can be connected to the provider 104 via a wireless interface. Client 102 can be configured to aggregate a plurality of preview information from a plurality of providers 104. The aggregated information can be displayed in an user interface (UI) on monitor 106. Monitor 106 can be an external component, or alternatively, monitor 106 can be integrated within client 102.

In an embodiment, provider 104 can be a search engine for indexing a multitude of information found on the Internet. In another embodiment, provider 104 can be a third party provider that is connected to an external search engine. In such an embodiment, client 102 can aggregate preview information from provider 104 that the provider 104 originally receives from a search engine.

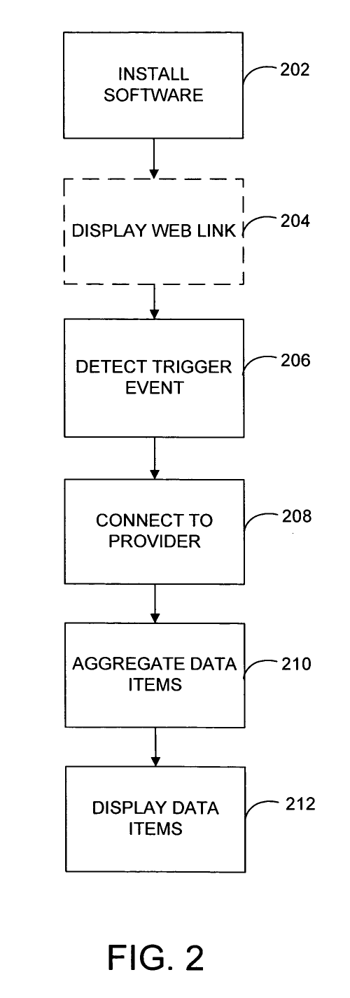

FIG. 2 illustrates an embodiment of a method for displaying preview information within a UI. A client can obtain the functionality to display preview information by installing software that includes client-based code. For example, a client can gain the ability to present preview information by installing a web browser, a toolbar, or by installing any other plug-in that can integrate with a browser. Alternatively, a website can provide the functionality for displaying preview information within a UI by utilizing Java script. For example, the owner of a search results page may be able to put Java script on the search results page that can enable the preview information to be loaded into a section within a UI of the client. In step 204, a web link can be displayed to a user on the UI. Displaying a web link can include displaying any accessible web link that may be encountered by a user on the UI which can include, but should not be limited to, web links encountered in web browsing, search results pages, and emails. However, if a user is interested in receiving preview information regarding a website the user is currently browsing, then it may not be necessary to display a web link.

In step 206, the installed software can detect a trigger event that can cause the software to retrieve and display the preview information. A trigger event can be any event, action, or occurrence that can initiate a request for the preview information. The invention can be configured to display preview information regarding a website that corresponds to a web link encountered by a user, and the invention can be configured to display preview information regarding a website a user is currently browsing. When a user encounters a web link and wishes to retrieve preview information for the corresponding website, the trigger event can comprise the user accessing the web link. Such a trigger event can be detected by, for example, an internet browser generating a software event such as OnNavigate. Accessing the web link can include, for example, hovering a mouse cursor over the web link, hovering a mouse cursor over an icon or selecting an icon with a mouse cursor, any other form of selecting the web link with a mouse cursor, or any type of key combination inputted into a keyboard. Modifying the behavior of a browser on mouse hover can be accomplished by altering the ONMOUSEOVER property of a hyperlink. Accessing the web link can additionally include any other input command into an external device that can be connected to the client that can reference the web link. This input command can be implemented, for example, with a UI button. When a user wishes to retrieve preview information regarding a website the user is currently browsing, a trigger event can include a user selecting an option that informs the software to retrieve the preview information. The selection of an option that informs the software to retrieve the preview information can comprise the user making a selection at designated area within the UI. The selection of an option that informs the software to retrieve the preview information can additionally comprise a key combination inputted into a keyboard or any other input command into an external device that can be connected to the client.

Once a trigger event has been detected by the software, the software can connect to a provider at step 208 to retrieve the preview information for a website corresponding to the encountered web link or for the website the user is currently browsing. This connection can be accomplished, for example, via an HTTP protocol. When connecting to the provider, the software can transmit a URL of the web link along with contextual information that can range from a user task (such as a considering visiting a website, browsing search results, currently visiting a website, Instant Message conversation, etc.), language types, types of information wanted based on user preferences, etc. The provider can use the information given by the software to search for and return relevant preview information to the client.

The provider can be, for example, a search engine that can index a plurality of information regarding a plurality of websites. The indexed information can come from a plurality of sources available to the search engine. The plurality of sources can include a website corresponding to the web link, the website the user is currently browsing, and any other third-party application or website that can provide information regarding another website. Alternatively, the provider can be a third party who can connect to a search engine to provide the information that has been indexed by the search engine. The indexed information can include a plurality of data items that can describe characteristics of a multitude of websites. A subset of data items, that can be relevant to the information sent to the provider from the client, can be used as the preview information to be transmitted back to a client and displayed to a user. Being that the information can come from a plurality of sources, the web link that the user encounters or the website that a user is currently browsing can correspond to a first source, a website for example, and the preview information can come from at least one second source other than the first source.

The plurality of data items that comprise the preview information can include any information that can be available or that can be indexed by a search engine. The data items can include but is not limited to: the last modified date for the content on the website, information regarding what people are saying about the website, the trustworthiness of the website such as a risk rating or information detailing whether the website is a known malware distributor, a popularity rating of the website, popular search queries that have brought users to the website, new or updated pages on the website, pop-up ads or malware present on the website, a thumbnail preview of page contents of the website, a full-page thumbnail of the website with search keywords highlighted, extended page excerpts and contextual descriptions of the website, a thumbnail preview of a blocked pop-up on the website, other websites with content related to the website, other websites that link to or from the website, a search results set if the web page was found via an Internet search, etc.

Once the provider has searched for relevant preview information corresponding to the information transmitted by the software, the provider can send the preview information to the client and the software can aggregate the preview information that contains the plurality of data items for the client at step 210. The client can then display the plurality of data items in a UI for the user at step 212.

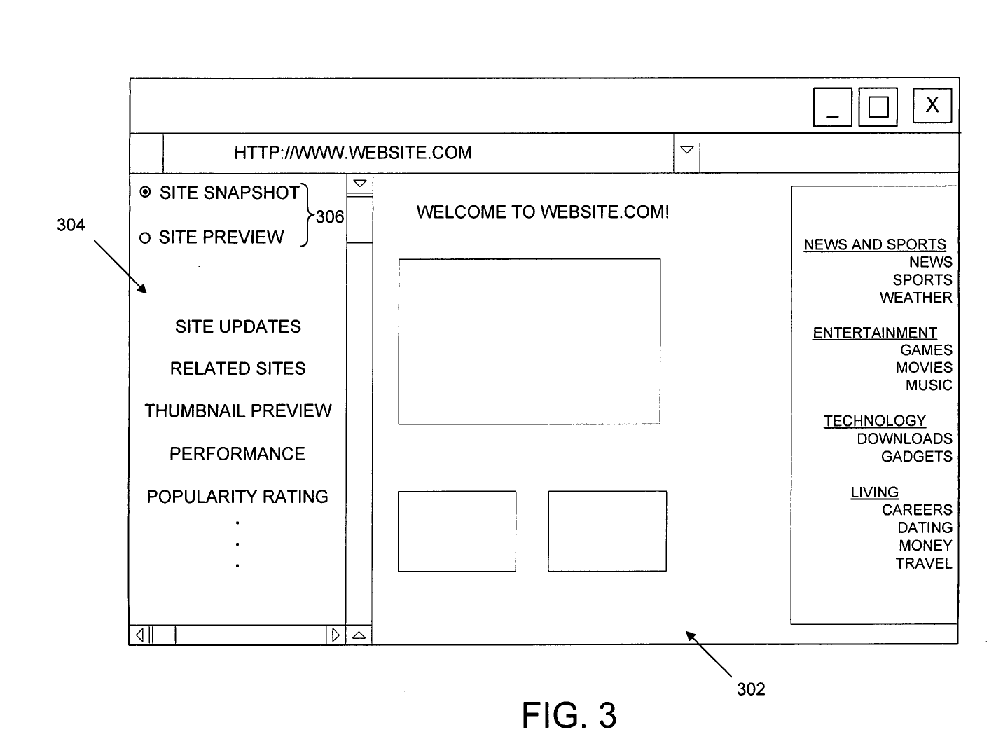

FIG. 3 illustrates an embodiment of a UI for displaying preview information for a website a user is currently browsing. The UI can include a main viewing section 302 and a preview information section 304. The main viewing section 302 can include a web browsing section, an email section, a word processing section, a document creation section, or any other viewable section other than the preview information section 304. The preview information section 304 can include a listing of preview information for the website the user is currently browsing. The preview information can comprise a plurality of data items, as mentioned above, that can describe characteristics of the website the user is currently browsing. The preview information section can additionally include a selection mechanism 306 which can allow a user to interchange between a first mode for displaying preview information for the website the user is currently browsing and a second mode for displaying preview information for a website that a user may consider visiting. As shown in FIG. 3, a “Site Snapshot” mode can be an example of a mode for displaying preview information for a website the user is currently browsing. When the user selects such a mode, the preview information can be retrieved and displayed in the preview information section 304 for any website the user is currently browsing.

In an embodiment, the preview information section 304 can be displayed in a pane that can be separate from the main viewing section 302. As shown in FIG. 3, the preview information section can be displayed in a left-docked pane that is to the left of the main viewing section 302, or the preview information section can be displayed in a right-docked pane that is to the right of the main viewing section 302. Alternatively, the preview information can be displayed in a pane that is above the main viewing section 302, or the preview information section can be displayed in a pane that is below the main viewing section 302. In such embodiments utilizing panes, the pane can be displayed in the UI in a fashion that does not block any viewable areas of the main viewing section while retaining the main viewing section. A viewable area can be any area on the main viewing section that is capable of displaying any type of multimedia information. A viewable area can include any area that is currently displaying multimedia information. A viewable area can also include any area that is not currently displaying multimedia information but is capable of displaying multimedia information. In another embodiment, the preview information section 304 can be presented in a pinned tab display that can be to the left, to the right, above, or below the main viewing section 302. The pinned tab display can a functional browsing section that can be similar to main viewing section 302 by allowing a user to browse a website. In yet another embodiment, the preview information section 304 can be displayed in a pop-up window that can be presented in any area of the UI.

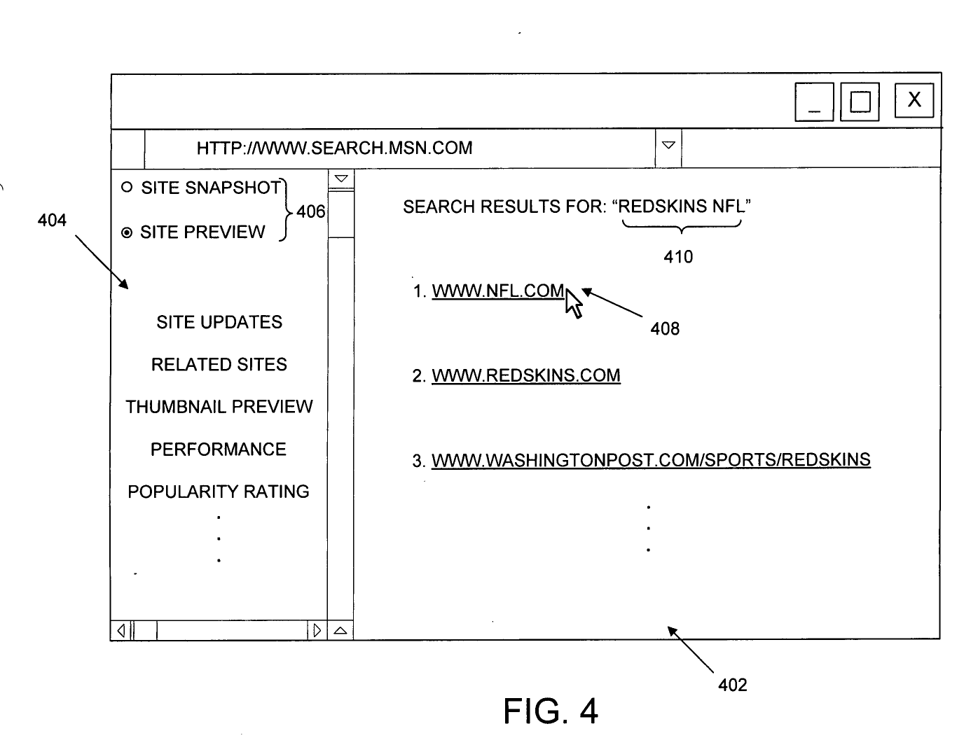

FIG. 4 illustrates an embodiment of a UI for displaying preview information for a website that a user may consider visiting by executing a trigger event upon an encountered web link. The UI can include a main viewing section 402 and a preview information section 404. The main viewing section 402 can include a web browsing section, an email section, a word processing section, a document creation section, or any other viewable section other than the preview viewing section 404. The preview information section 404 can include a listing of preview information for the website that the user may consider visiting. The preview information can comprise a plurality of data items, as mentioned above, that can describe characteristics of the website that the user may consider visiting. The preview information section can additionally include a selection mechanism 406 which can allow a user to interchange between a first mode for displaying preview information for the website the user is currently browsing and a second mode for displaying preview information for a website that a user may consider visiting.

As shown in FIG. 4, a “Site Preview” mode can be an example of a mode for displaying preview information for a website that the user may consider visiting. When a user selects such a mode, preview information can be retrieved and displayed in the preview information section when a trigger event is detected for a web link encountered by the user. For example, as shown in FIG. 4, a trigger event 408 can include a user hovering over the web link www.nfl.com with a mouse cursor. Once the trigger event has been detected, preview information for a website corresponding to the web link can be displayed in the preview information section 404.

FIG. 4 also illustrates an embodiment for displaying preview information for a website that corresponds to an encountered web link included in a search results page. As shown in FIG. 4, the web links encountered in the main viewing section can correspond to a search query that can derive from search terms 410. When a user activates a trigger event upon a web link that corresponds to the search query, preview information for a web site that can be associated with the web link can be displayed in the preview information section 404.

In an embodiment, the preview information section 404 can be displayed in a pane that can be separate from the main viewing section 402. As shown in FIG. 4, the preview information section can be displayed in a left-docked pane that is to the left of the main viewing section 402, or the preview information section can be displayed in a right-docked pane that is to the right of the main viewing section 402. Alternatively, the preview information can be displayed in a pane that is above the main viewing section 402, or the preview information section can be displayed in a pane that is below the main viewing section 402. In such embodiments utilizing panes, the pane can be displayed in the UI in a fashion that does not block any viewable areas of the main viewing section while retaining the web link in the main viewing section. A viewable area can be any area on the main viewing section that is capable of displaying any type of multimedia information. A viewable area can include any area that is currently displaying multimedia information. A viewable area can also include any area that is not currently displaying multimedia information but is capable of displaying multimedia information. In another embodiment, the preview information section 404 can be presented in a pinned tab display that can be to the left, to the right, above, or below the main viewing section 402. The pinned tab display can a functional browsing section that can be similar to main viewing section 402 by allowing a user to browse a website. In yet another embodiment, the preview information section 404 can be displayed in a pop-up window that can be presented in any area of the UI.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

We claim:

1. A method for displaying preview information for a website, comprising:
displaying a web link in a first section;
detecting a trigger event;
aggregating a plurality of data items corresponding to the web link; and
displaying the plurality of data items in a second section while retaining the web link in the first section, wherein the second section does not block any viewable areas of the first section.

2. The method according to claim 1, wherein the trigger event includes accessing the web link.

3. The method according to claim 1, wherein the web link is included in a search results page that corresponds to a search request.

4. The method according to claim 1, wherein the plurality of data items includes information that describes characteristics of a website corresponding to the web link.

5. The method according to claim 1, wherein the web link corresponds to a first source and the data items are aggregated from at least one second source.

6. The method according to claim 1, wherein the plurality of data items are aggregated from a plurality of sources.

7. The method according to claim 1, further comprising switching to a mode for aggregating and displaying a plurality of data items that describe characteristics of a website currently being displayed.

8. A method for transmitting preview information for a website, comprising:
displaying a web link in a first section;
detecting a trigger event;
connecting to an index of a plurality of data items, the plurality of data items being accumulated from more than one source;
aggregating a subset of data items from the plurality of data items, the subset of data items corresponding to the web link;
displaying a subset of data items in a second section while retaining the web link in the first section, wherein the second section does not block any viewable areas of the first section.

9. The method according to claim 8, wherein the web link is included in a search results page that corresponds to a search request.

10. The method according to claim 8, wherein the index is generated by a search engine.

11. The method according to claim 8, wherein the subset of data items includes information that describes characteristics of a website corresponding to the web link.

12. The method according to claim 8, further comprising switching to a mode for aggregating and displaying a plurality of data items that describe characteristics of a website currently being displayed.

13. The method according to claim 8, wherein the website corresponds to a first source and the subset of data items are accumulated from at least one second source.

14. A computer readable media with instructions for processing a method for displaying preview information for a website, the method comprising:
displaying a web link in a first section;
detecting a trigger event;
aggregating a plurality of data items corresponding to the web link; and
displaying the plurality of data items in a second section while retaining the web link in the first section, wherein the second section does not block any viewable areas of the first section.

15. The computer readable medium according to claim 14, wherein the trigger event includes accessing the web link.

16. The computer readable medium according to claim 14, wherein the web link is included in a search results page that corresponds to a search request.

17. The computer readable medium according to claim 14, wherein the plurality of data items includes information that describes characteristics of a website corresponding to the web link.

18. The computer readable medium according to claim 14, wherein the web link corresponds to a first source and the data items are aggregated from at least one second source.

19. The computer readable medium according to claim 14, wherein the plurality of data items are aggregated from a plurality of sources.

20. The computer readable medium according to claim 14, further comprising switching to a mode for aggregating and displaying a plurality of data items that describe characteristics of a website currently being displayed.
